(19) United States
(12) Patent Application Publication
(10) Pub. No.: US 2008/0297980 A1
(43) Pub. Date: Dec. 4, 2008

(54) Layered carbon electrodes useful in electric double layer capacitors and capacitive deionization and methods of making the same

(76) Inventors: Roy Joseph Bourcier, Corning, NY (US); Todd P. St Clair, Painted Post, NY (US); Prantik Mazumder, Ithaca, NY (US); Andrew R. Nadjadi, JR., Canisteo, NY (US); Vitor Marino Schneider, Painted Post, NY (US)

Correspondence Address: CORNING INCORPORATED, SP-TI-3-1, CORNING, NY, 14831, US

(21) Appl. No.: 11/807,981

(22) Filed: May 31, 2007

(51) Int. Cl. H01G 9/042; B05D 5/12

(52) U.S. Cl. 361/502; 427/79; 427/80; 29/25.03

(57) ABSTRACT

Carbon electrodes for use in, for example, Capacitive Deionization (CDI) of a fluid stream or, for example, an electric double layer capacitor (EDCL). Methods of making the carbon electrodes are also described. The carbon electrode comprises an electrically conductive porous carbon support and a carbon cover layer comprising carbon particles in contact with the electrically conductive porous carbon support. A carbonizable material is within the electrically conductive porous carbon support and provides a bond to the carbon particles at the interface of the electrically conductive porous carbon support and the carbon cover layer. The electrically conductive porous support in some embodiments is a layered structure, where one of the layers is a carbonizable paste layer having electrically conductive particles mixed therein.

### BACKGROUND

1. Field of the Invention

The present invention relates generally to carbon electrodes and layered structures and more particularly to an all carbon electrode and a layered structure useful for electric double layer capacitors and/or for capacitive deionization and methods of making the same.

2. Technical Background

An electric double layer capacitor (EDLC) is an example of a capacitor that typically contains carbon electrodes (separated via a porous separator), current collectors and an electrolyte solution. When electric potential is applied to an EDLC cell, ionic current flows due to the attraction of anions to the positive electrode and cations to the negative electrode. Electric charge is stored at the interface between each polarized electrode and the electrolyte solution.

EDLC designs vary depending on application and can include, for example, standard jelly roll designs, prismatic designs, honeycomb designs, hybrid designs or other designs known in the art. The energy density and the specific power of an EDLC can be affected by the properties thereof, including the electrode and the electrolyte utilized. With respect to the electrode, high surface area carbons, carbon nanotubes, activated carbon and other forms of carbon and composites have been utilized in manufacturing such devices. Of these, carbon based electrodes are used in commercially available devices.

Capacitive Deionization (CDI) is a promising technology, for instance, for the purification of water. In this context, positively and negatively charged electrodes are used to attract ions from a stream or bath of fluid. The ions form electric double layers on the surfaces of the electrodes, which are fabricated from some form of high surface area material, for example, a form of activated carbon. After passing over the electrodes, the fluid contains a lower overall ion content and is discharged. A volume of purge fluid is then introduced to the electrodes. The electrodes are then electrically discharged, thus releasing the trapped ions into the purge fluid. The purge fluid is then diverted into a waste stream and the process repeated.

In U.S. Pat. No. 5,954,937, CDI electrodes are described which are based on a resorcinol/formaldehyde carbon aerogel technology. Carbon paper sheets are soaked with a polymer resorcinol/formaldehyde resin and subsequently pyrolyzed. Sol-gel processing and supercritical drying are traditionally used to obtain an aerogel structure prior to pyrolysis. The resulting electrodes are thin, monolithic carbon structures. The aerogel surface of these electrode sheets and the carbon paper itself are delicate and need to be protected from mechanical stressing which can cause damage to the electrodes, rendering the electrodes inoperable.

The electrodes are then bonded to a titanium sheet current collector using a conductive carbon filled adhesive. The large area of contact between the electrode and the current collector ensures relatively low overall resistance despite the moderately high resistivity of the adhesive interface. The resulting electrodes possess good CDI performance, but are extremely costly. Limited success has been achieved at applying subcritical drying to reduce cost. Also, these electrodes possess a very modest level of total capacitance per unit area, since the aerogel layer is thin and possesses limited surface area. This reduced level of capacitance increases the number of electrode sheets required for a given system which further increases the cost.

In U.S. Pat. No. 6,778,378, electrodes are described which are fabricated by blending activated carbon powder, fibrillated polytetrafluoroethylene (PTFE) and a liquid, forming a paste-like material. The resulting paste-like material is then rolled into a composite sheet. Electrodes formed in this fashion are thin, flexible sheets with good specific capacitance. A large fraction of this capacitance value is a result of the activated carbon used.

However, the particle to particle connectivity of the carbon particles in the activated carbon is typically poor and these electrodes have high electronic resistance compared to the monolithic aerogel electrodes. A separate current collector sheet, typically made of rolled exfoliated graphite material, is clamped to the electrode back surface with a large compressive force to obtain the necessary electrical performance, thus increasing the cost and the complexity of a CDI device made using these electrodes. Also these rolled composite sheets, due to the purely mechanical nature of the PTFE/carbon bonding, have only modest erosion resistance. For this reason, when eliminating particulates from the fluid stream, the flow rates of the fluid stream need to be minimized across the surface of these electrodes.

A flow-through (rather than parallel plate) flow geometry is described in commonly owned U.S. Pat. No. 6,214,204, the disclosure of which is incorporated herein by reference in its entirety. In this reference, monolithic, low back pressure porous electrodes are made by one of several methods, which include honeycomb extrusion, casting or molding from a phenolic resin-based batch. After curing, these parts are carbonized and activated to create high surface area carbon monoliths with good electrical conductivity.

The resulting electrodes have some disadvantages, for example, limited mechanical strength, since the electrodes comprise a porous and brittle material. Thus, manufacturing thin, large diameter electrodes for high performance is challenging and packaging the electrodes into a CDI system is also challenging. Also, because they do not have a conductive graphitic backplane, their electronic conductivity is low as compared to the carbon paper-based aerogel electrodes.

Commonly owned U.S. patent application Ser. No. 11/799,901, the disclosure of which is incorporated by reference in its entirety, describes a layered carbon electrode comprising an electrically conductive porous layer and an adjacent layer comprising carbon particles in contact with the electrically conductive porous layer. A thermoplastic material is infused in the electrically conductive porous layer and provides a bond to the carbon particles at the interface of the electrically conductive porous layer and the adjacent layer comprising carbon particles. The electrically conductive porous layer, which serves as the conductive backplane of the electrode, is first infiltrated or infused with the thermoplastic material. One or both surfaces of the electrically conductive porous layer is/are then covered with the high surface area carbon particles and pressure is applied. Heat is applied to remelt the thermoplastic material, which wicks out from the electrically conductive porous layer and provides a bond, wetting the carbon particles and bonding the carbon particles to the electrically conductive porous layer. The resulting carbon electrodes have good electrical conductivity because of the integrated electrical backplane. The carbon electrodes show good capacitive performance, resulting from highly effective utilization of the carbon particles. And most importantly they have low time constants (˜10 s) due to the processing flexibility related to making the carbon electrodes reasonably thin. In part because of their good mechanical strength and toughness, the electrodes may incorporate an array of punched holes, which can be used to enable a variety of geometries.

U.S. Pat. No. 5,443,859 describes a method of manufacturing high conductivity carbonized films made from a polyimide.

Several types of photoresists are described in the Journal of Electrochemical Society, 152 (12), pp. J136-J143 (2005) for the manufacturing of carbonized films with high conductivity. A process for the manufacturing of carbonized films from photoresists such as PMMA and SU-8 is described for micromechanical systems.

It would be advantageous to develop cost-effective, electrochemically inert and mechanically robust carbon electrodes with high specific capacitance and low electrical resistance. Also, it would be advantageous for the carbon electrodes to be easily processed into different geometries which could enable various fluidic schemes.

### SUMMARY

Carbon electrodes and layered structures useful for electric double layer capacitors (EDLC) and for capacitive deionization and methods of making the same are described herein. The carbon electrodes, layered structures and the methods of making the carbon electrodes of the present invention as described herein, address one or more of the above-mentioned disadvantages of the conventional electrodes.

In one embodiment, a carbon electrode is disclosed. The carbon electrode comprises an electrically conductive porous carbon support, an adjacent carbon cover layer comprising carbon particles in contact with the electrically conductive porous carbon support and a carbonized material within the electrically conductive porous carbon support and providing a bond to the carbon particles at the interface with the carbon cover layer.

According to another embodiment, a method of making a carbon electrode is disclosed. The method comprises providing an electrically conductive support, infusing the electrically conductive support with a carbonizable material, applying an adjacent carbon cover layer comprising carbon particles or precursors thereof to the electrically conductive support, curing the carbonizable material and carbonizing the electrically conductive support and the carbon cover layer to form the carbon electrode.

In another embodiment, a method of making a carbon electrode is disclosed. The method comprises providing an electrically conductive porous layer, applying a carbonizable paste layer comprising electrically conductive particles and a carbonizable polymer material to the electrically conductive porous layer, applying a carbon cover layer comprising carbon particles or precursors thereof to the paste layer, infusing the electrically conductive porous layer with a carbonizable material, curing the carbonizable polymer material and the carbonizable material and carbonizing the layers to form the carbon electrode.

According to another embodiment, a layered structure is disclosed. The layered structure comprises an electrically conductive support, an adjacent carbon cover layer comprising carbon particles or precursors thereof in contact with the electrically conductive support and a carbonizable material within the electrically conductive support and providing a bond to the carbon particles or precursors thereof at the interface with the carbon cover layer.

Layered structures and carbon electrodes made according to the methods described herein possess one or more desirable advantages, for example, the electrically conductive support of the layered structure and the electrically conductive porous carbon support of the carbon electrode provide a high performance electrical backplane for the layered structure and the carbon electrode.

The carbonizable material which is within the electrically conductive support of the layered structure, or the carbonized material within the electrically conductive porous carbon support of the carbon electrode, can improve the mechanical integrity of the layered structure and the carbon electrode by toughening the otherwise brittle supports by forming a strong, interlocking, mechanical bond between the support and the carbon particles. The carbonized material provides both mechanical bonding and additional electrical connectivity between the carbon particles and the support in the carbon electrode.

Also, increased electrical contact between the carbon particles in the carbon cover layer and the support can be achieved and maintained in the carbonized, or carbonized and activated, carbon electrode, thus yielding a carbon electrode with low electronic resistance.

The carbon electrodes of the present invention possess increased fluidic access to the carbon particles (e.g. high surface area carbon powder) which is maintained in the carbonized or carbonized and activated carbon electrode. Unlike rolled carbon/PTFE electrodes, the capacitive element of the carbon electrodes of the present invention contains relatively large carbon particles, most of whose surface is directly exposed to an electrolyte in a device comprising the carbon electrodes.

Further advantages of layered structures and carbon electrodes according to the present invention are that the layered structures and carbon electrodes and methods of making the carbon electrodes can utilize a range of different carbon powders in the carbon cover layer, providing an opportunity for performance enhancement and/or fine tuning. The mechanical properties, for example, strength and integrity of the layered structures and the carbon electrodes (relative to conventional CDI electrodes) enable the layered structures and the carbon electrodes of the present invention to easily be used in parallel, transverse, or hybrid parallel/transverse flow geometries. The methods of making the carbon electrodes and the inexpensive components result in carbon electrodes which can be increasingly cost-effective.

Additional features and advantages of the invention will be set forth in the detailed description which follows, and in part will be readily apparent to those skilled in the art from the description or recognized by practicing the invention as described in the written description and claims hereof, as well as the appended drawings.

It is to be understood that both the foregoing general description and the following detailed description are merely exemplary of the invention, and are intended to provide an overview or framework to understanding the nature and character of the invention as it is claimed.

The accompanying drawings are included to provide a further understanding of the invention, and are incorporated in and constitute a part of this specification. The drawings illustrate one or more embodiment(s) of the invention and together with the description serve to explain the principles and operation of the invention.

### BRIEF DESCRIPTION OF THE DRAWINGS

The invention can be understood from the following detailed description either alone or together with the accompanying drawing figures.

FIG. 1 is a scanning electron microscope (SEM) image of a cross section of a carbon electrode according to one embodiment.

FIG. 2 is a SEM image of a cross section of a carbon electrode according to one embodiment.

FIG. 3 is a SEM image of a top down view of a carbon electrode according to one embodiment.

FIG. 4 is a SEM image of a cross section of a carbon electrode according to one embodiment.

FIG. 5 is an optical photograph of a cross section of a layered structure according to one embodiment.

FIG. 6 is a schematic of a method of making a carbon electrode according to one embodiment.

FIG. 7 is a schematic of a method of making a carbon electrode according to one embodiment.

FIG. 8 is a graph of the electrochemical impedance spectroscopy (EIS) test results for a carbon electrode according to one embodiment.

FIG. 9 is a graph of the Cyclic voltammetry (CV) test results for a carbon electrode according to one embodiment.

FIG. 10 is a graph of the Galvanostatic test results for a carbon electrode according to one embodiment.

### DETAILED DESCRIPTION

Reference will now be made in detail to various embodiments of the invention, examples of which are illustrated in the accompanying drawings. Wherever possible, the same reference numbers will be used throughout the drawings to refer to the same or like parts.

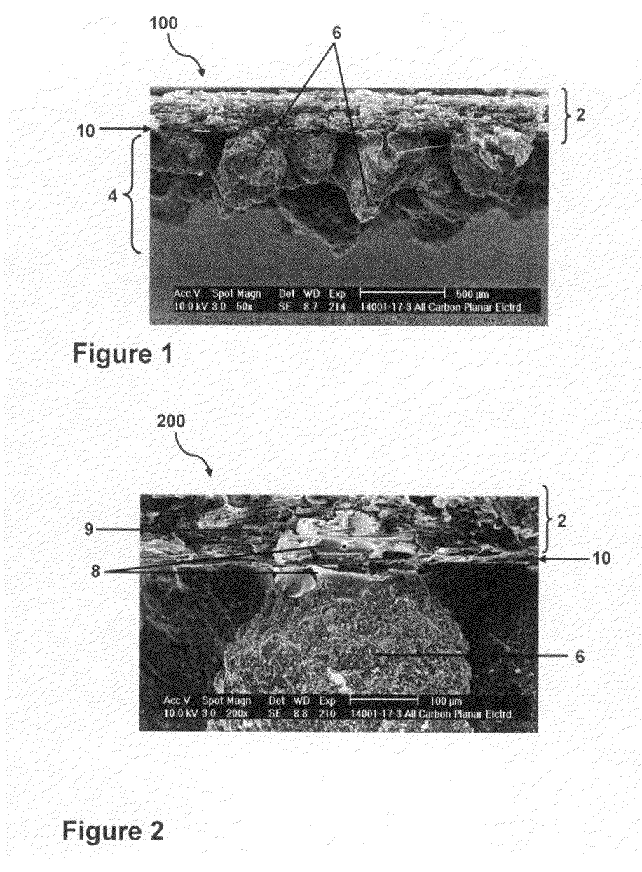

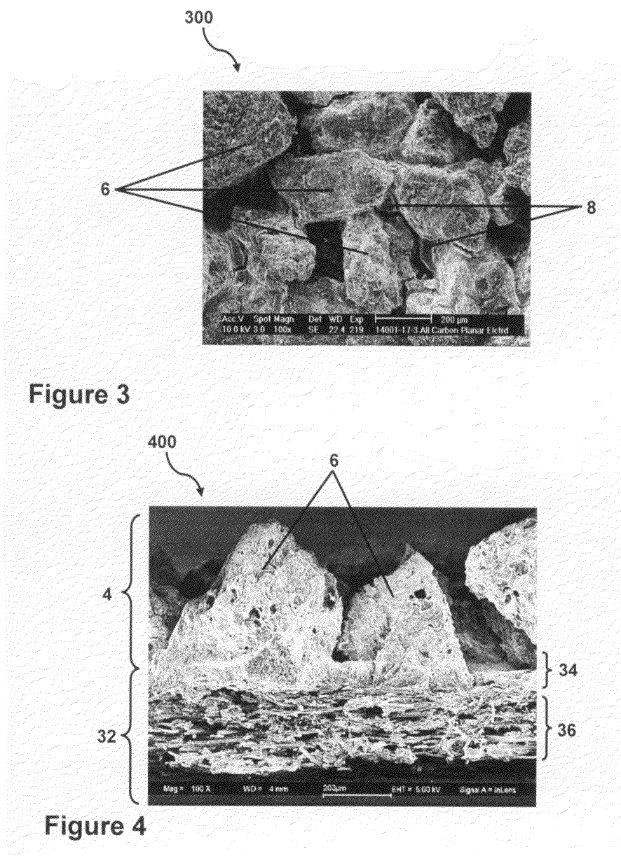

In embodiments, as shown in FIG. 1, FIG. 2 and FIG. 3, a carbon electrode 100, 200, 300 respectively comprises a carbon cover layer 4 comprising carbon particles 6 in contact with an electrically conductive porous carbon support 2. A carbonized material 8 is within the electrically conductive porous carbon support 2 and provides a bond to the carbon particles 6 at the interface 10 with the carbon cover layer 4.

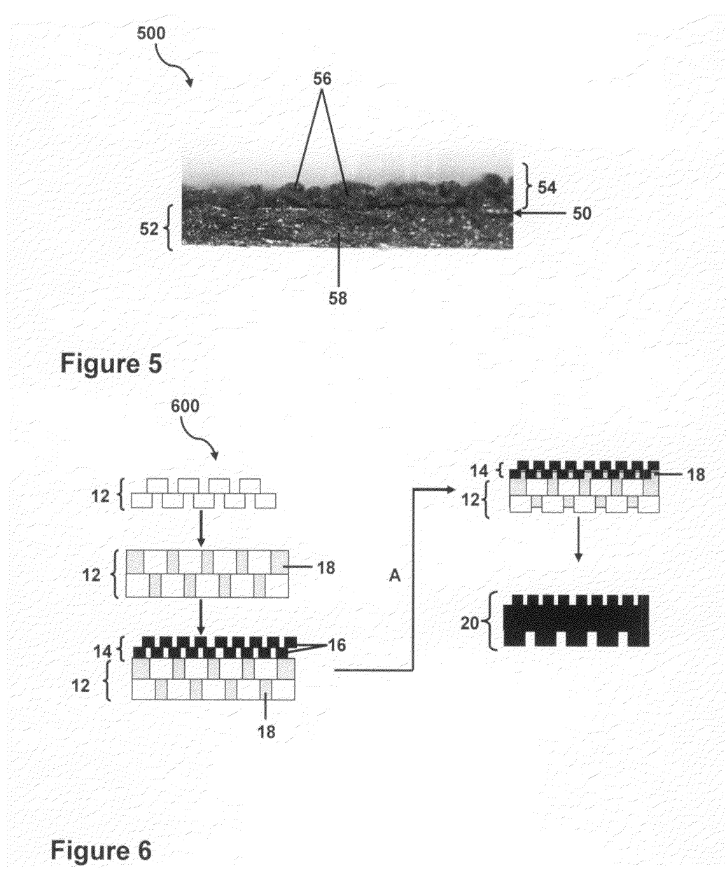

In another embodiment, as shown in FIG. 5, a layered structure is disclosed. The layered structure 500 comprises an electrically conductive support 52, an adjacent carbon cover layer 54 comprising carbon particles or precursors thereof 56 in contact with the electrically conductive support 52 and a carbonizable material 58 within the electrically conductive support and providing a bond to the carbon particles or precursors thereof 56 at the interface 50 with the carbon cover layer 54. In this embodiment, the electrically conductive support comprises two layers, wherein at least one layer is a carbonized paste layer comprising electrically conductive particles and a carbonized polymer material, wherein the carbonized paste layer is in contact with the carbon particles in the carbon cover layer. In this embodiment, a commercially available phenol formaldehyde resole resin, specifically Georgia Pacific Phenolic Resin GP510 D50 Resi-Set (“GP Resin”), optionally catalyzed with a phosphoric acid addition is the carbonizable material.

In another embodiment, the electrically conductive porous carbon support of the carbon electrode or the electrically conductive support of the layered structure (commonly referred to herein as “support”) is a single carbon layer infused with the carbonized material (in the case of the carbon electrode of the invention) or carbonizable material (in the case of the layered structure of the invention). In some embodiments, the single carbon layer comprises a porous carbon sheet. One function of the support is that of an electrical backplane or current collector. Therefore, it is advantageous that the support have good electrical conductivity. Unfortunately, carbon is a modest electrical conductor in the best of cases. However, carbon possesses a high degree of electrochemical stability when used in a CDI environment, for example, in a fluid containing salt (NaCl).

Several materials currently used in the art have one or more of the following disadvantages: the materials either aggressively corrode or dissolve under electrical potential in saltwater or the materials are prohibitively expensive. The application of corrosion-resistant coatings to more reactive conductive materials does not seem practical, given the extremely aggressive nature of the mixed-ion saltwater capacitive deionization environment.

Fortunately, the electrical resistivity of carbon is sufficiently low that the ionic resistance of the high surface area carbon powder and the solution resistance of the saltwater render the materials utilized by the present invention, for example, carbon, advantageous.

In another embodiment of a carbon electrode 400, as shown in FIG. 4, the electrically conductive porous carbon support 32 comprises two layers 34 and 36, wherein at least one layer is a carbonized paste layer 34 comprising electrically conductive particles and a carbonized polymer material, wherein the carbonized paste layer 34 is in contact with the carbon particles 6 in the carbon cover layer 4. In this embodiment, the layer 36 comprises a polyacrylonitrile (PAN) fiber based carbon paper manufactured by Toray as described below. In this embodiment, the carbonized polymer material is a carbonized phenolic resin and the carbon particles are high surface area GAC carbon particles.

In one embodiment, the support or a layer therein can take several forms, for example, carbon paper, carbon fibers, synthetic fiber carbon felt, carbon foam, carbon cloth or combinations thereof.

In one embodiment 200, as shown in FIG. 2, a carbon cover layer comprising carbon particles 6 is in contact with the electrically conductive porous carbon support 2, and a carbonized material 8 is within the electrically conductive porous carbon support 2 and provides a bond to the carbon particles 6 at the interface 10 with the carbon cover layer.

In this embodiment, a polyacrylonitrile (PAN) fiber based carbon paper manufactured by Toray is the electrically conductive porous carbon support 2. This PAN fiber based carbon paper comprises carbon fibers 9, and is highly porous (comprising approximately 80% porosity by volume of the paper) with low resistivity (approximately 5.6 mohm-cm), making the PAN fiber based paper a suitable electrically conductive porous carbon support and a reservoir for the carbonized material 8 for providing a bond to the carbon particles 6.

According to another embodiment, a synthetic fiber carbon felt can be used as the support or as a layer therein. This material could provide a cost reduction to the manufacturing of the carbon electrodes when compared to the costly PAN fiber based carbon paper. The carbonized material within the electrically conductive porous carbon support used in the carbon electrodes should greatly strengthen and toughen the synthetic fiber carbon felt, making it useful for CDI applications where the PAN fiber based paper could otherwise prove too fragile.

Toray TGP-H-090 carbon paper is a PAN fiber based paper made by Toray Marketing and Sales, 461 Fifth Ave., 9th Fl., New York, N.Y. Fiber based papers manufactured by Toray are commercially available at 190, 280 and 370 microns in thickness. The support or a layer therein, according to other embodiments, can comprise a planar sheet which is, for example, 50 to 500 microns in thickness or 125 to 400 microns in thickness. In other embodiments, the support or layer therein comprises a planar surface.

According to another embodiment, carbon foam, for example PocoFoam available from Poco Graphite, Inc. can be used as the support or as a layer therein.

In another embodiment, two surfaces of the electrically conductive porous carbon support with the carbonized material within the electrically conductive porous carbon support are in contact with separate respective carbon cover layers comprising carbon particles, thus providing a carbon cover layer comprising carbon particles on two sides of the support. For example, the carbon electrode may comprise a planar electrically conductive porous carbon support sandwiched between adjacent carbon cover layers comprising carbon particles.

In another embodiment, the electrically conductive porous carbon support comprising two layers: 1) a carbonized paste layer comprising electrically conductive particles and a carbonized polymer material and 2) a porous carbon sheet, can further comprise a third layer comprising a carbonized paste layer comprising electrically conductive particles and a carbonized polymer material, wherein the respective carbonized paste layers are in contact with the respective carbon cover layers. For example, the carbon electrode may comprise a planar electrically conductive porous carbon sheet sandwiched between adjacent carbonized paste layers, each of which are adjacent to carbon cover layers comprising carbon particles.

According to another embodiment, a surface of the electrically conductive porous carbon support or the electrically conductive support of the layered structure is in contact with the carbon particles of the carbon cover layer in a pattern, thus providing areas in the carbon cover layer comprising carbon particles and areas in the same carbon cover layer lacking the carbon particles. The pattern of carbon particles can be, for example, applied in discrete regions, periodic, in a pattern resembling a road map, or such that an area in the carbon cover layer exists around the perimeter of a surface of the carbon electrode or layered structure. Such areas of the electrically conductive porous carbon support or electrically conductive support can provide areas for electrical contact for the carbon electrode or layered structure.

The carbonizable material in the layered structure, wherein the electrically conductive support is a single carbon layer infused with the carbonizable material should readily wet both the electrically conductive support and the carbon particles in the adjacent carbon cover layer. The carbonizable material should wet the electrically conductive support when applied and infiltrate the pore structure, thus becoming infused in the pore structure. Upon application of the carbon cover layer, a fraction of the carbonizable material should wick out of the pores of the electrically conductive support and wet the carbon particles forming fillets there between. In other embodiments, the carbonizable material comprises a material selected from a phenol formaldehyde resole, a photoresist, a polyamide, a phenol formaldehyde novolac, a polyimide, a phenolic resin, an epoxy, a petroleum pitch, a synthetic pitch and combinations thereof.

It is advantageous that the carbonizable material be capable of being carbonized into a monolithic form with good mechanical integrity and that the weight loss upon carbonization is 50% or less. In other embodiments, the weight loss upon carbonization is 30% or less. Weight loss of the carbonizable material greater than 50% upon carbonization may be a source of cracking and microcracking of the carbon electrode, thus reducing mechanical strength and electrical conductivity.

According to another embodiment, the carbonizable material in the carbonized form (i.e. carbonized material) can be graphitic in nature, which can impart a higher electrical conductivity to the carbon electrode.

According to one embodiment, the carbonizable material has a viscosity, when uncured, of from 100 to 20,000 centipoise (cP) at a temperature in the range of from 20° C. to 100° C.

According to another embodiment, the carbonizable material has a viscosity, when uncured, of from 400 to 2000 centipoise (cP) at a temperature in the range of from 20° C. to 40° C.

In embodiments where the electrically conductive support comprises a carbonizable paste layer comprising electrically conductive particles and a carbonizable polymer material, the carbonizable polymer material comprises a material selected from a phenol formaldehyde resole, a photoresist, a polyamide, a phenol formaldehyde novolac, a polyimide, a phenolic resin, an epoxy and combinations thereof.

The performance of the carbonizable polymer material may be enhanced by the addition of the electrically conductive particles. In one embodiment, the electrically conductive particles comprise carbon powder, carbon black, graphite, petroleum coke fibers, filaments, rods or combinations thereof. The electrically conductive particles can be, for example, spherical, fibrous, rod-like in shape or combinations thereof and be either in the micrometer or nanometer size ranges. The fibers, filaments, rods or combinations thereof can be carbon or graphitic in nature.

The electrically conductive particles can increase the viscosity of the carbonizable polymer material in the paste, thus reducing the tendency of the carbonizable polymer material in the paste to infiltrate the carbon particles in the carbon cover layer, which can increase the capacitive performance of the resulting carbon electrode or layered structure.

The electrically conductive particles can reduce the shrinkage of the carbonizable paste layer during curing and during carbonization, which can improve the dimensional stability of the carbon electrodes and layered structures and reduce the cracking of the polymer material when cured and when carbonized.

The electrically conductive particles can improve the conductivity of the polymer material when cured and when carbonized, thus the electronic conductivity of the resulting carbon electrode or layered structure, such that a cured only layered structure could be made with sufficient conductivity and capacity to be used as an EDLC.

According to one embodiment, the carbonizable paste layer comprises 35-50 weight percent (wt %) electrically conductive particles and having a Casson yield stress of from 10 to 10,000 Pa, for example, 43-48 wt % electrically conductive particles and having a Casson yield stress of from 125 to 5000 Pa.

In one embodiment, the carbon cover layer comprises carbon particles having an average diameter of from 10 microns to 1000 microns. In other embodiments, the carbon cover layer comprises carbon particles having an average diameter of from 75 microns to 600 microns. In other embodiments, the carbon cover layer comprises carbon particles having an average diameter of from 75 microns to 450 microns in diameter.

If the carbon particles in the carbon cover layer have average diameters of less than 10 microns, the surface of the electrically conductive support infused with the carbonizable material may be compromised. The carbonizable material may be unable to wet a continuous layer of fine particles, so only a very low mass loading of the carbon particles in the carbon cover layer would be realized. Further, in the carbon electrodes or layered structures, the fine particles can be essentially incorporated into the carbonizable material or the carbonizable polymer material and thus, sealed off from the surface of the layered structure. In this instance, providing minimal capacitance in the layered structure and reduced capacitance in the carbon electrode.

Conversely, if the carbon particles in the carbon cover layer have average diameters greater than 1000 microns, they may be tenuously bonded to the electrically conductive support. The tenuously bonded carbon particles tend to break loose from the electrically conductive support and can present a shorting hazard between adjacent carbon electrodes in, for example, a CDI cell. Carbon particles comprising average diameters of from 75 microns to 450 microns, yield advantageous particle mass loadings and optimized adhesion to the electrically conductive support.

This flexibility in useful average carbon particle sizes is advantageous over the conventional resorcinol/formaldehyde monolithic aerogel electrodes, which have a limited working range of microstructures.

In the embodiment comprising carbon particles in the carbon cover layer having an average diameter of from 10 microns to 1000 microns, it is also recognized that particles comprising carbon or other materials can be utilized which comprise average particle sizes of less than 10 microns or larger than 1000 microns included in the carbon cover layer comprising carbon particles of the present invention. The smaller particles, for example, nanoparticles, would not compromise the capacitive performance of the carbon electrode or the layered structure provided that the carbon particles in the carbon cover layer comprise an average diameter of from 10 microns to 1000 microns.

Further, it may be advantageous to use a bi-modal distribution (centered on ˜10 microns and ˜100 microns) of carbon particles in the carbon cover layer to maximize carbon particle packing and higher inter-particle contact in the carbon cover layer.

In one embodiment, the carbon particles in the carbon cover layer of the carbon electrode or of the layered structure comprise high surface area carbon, activated carbon or combinations thereof. High surface area carbon (from 800 m²/g to 2500 m²/g) is advantageous as the carbon particles in the carbon cover layer.

In one embodiment, the carbon precursor particles in the carbon cover layer in the layered structure comprise carbonizable polymer particles. The carbonizable polymer particles comprise a material selected from a phenol formaldehyde resole, a photoresist, a polyamide, a phenol formaldehyde novolac, a polyimide, a phenolic resin, an epoxy and combinations thereof.

An advantage of the carbon electrodes and the layered structures described by the present invention is their mechanical stiffness and fracture toughness. This facilitates the processing of the carbon electrodes and the layered structure into several geometric designs, for example, parallel, transverse, or hybrid parallel/transverse flow geometries.

According to another embodiment, carbon electrodes or layered structures which have been coated with high surface area carbon powder on one surface may be bonded together back to back using a polymer adhesive, for example, a low viscosity thermopolymer or a non-conductive porous separation layer, for example, a fabric filter.

Composite two-sided electrodes made in this fashion can possess exceptional mechanical strength. They can readily incorporate an array of punched holes or other preferred designs, which can be used to enable a hybrid parallel/transverse flow through CDI cell design. In one embodiment, the carbon electrode comprises a hole extending through the thickness of the electrode. The hole can be, for example, from 1 mm to 10 mm in diameter.

FIG. 6 shows an exemplary method 600 of making a carbon electrode according to another embodiment. The method comprises providing an electrically conductive support 12, infusing the electrically conductive support 12 with a carbonizable material 18, applying an adjacent carbon cover layer 14 comprising carbon particles or precursors thereof 16 to the electrically conductive support 12, curing the carbonizable material 18 (see arrow A) and carbonizing the electrically conductive support 12 and the carbon cover layer 14 to form the carbon electrode 20.

In one embodiment, the electrically conductive support comprising a porous carbon sheet of the carbon electrode is first infiltrated with the carbonizable material. A thin film of the carbonizable material is located on one or both surfaces of the electrically conductive support and serves as the bonding agent for the high surface area carbon powder in the adjacent carbon cover layer. One or both surfaces of the infused electrically conductive support is/are then covered with the high surface area carbon powder and the carbonizable material wets the high surface area carbon powder, bonding the high surface area carbon powder to the surface of the porous carbon sheet. The carbonizable material is then cured, and subsequently carbonized, forming a fully carbon electrode with a highly interconnected electric pathway.

According to another embodiment, pressure may be applied to enhance direct electrical contact between the carbon cover layer and the support in the carbon electrode or in the layered structure. The applied pressure should be sufficiently high so as to bring the carbon particles or precursors thereof in the carbon cover layer and the electrically conductive support into intimate mechanical contact and facilitate wicking of a fraction of the carbonizable material to provide a bond between the two, but not so high so as to cause significant crushing damage to either the carbon cover layer or the electrically conductive support. The level of the applied pressure can be adjusted depending on the specific electrically conductive support and the carbon particles used.

In one embodiment, the application of 70 or more gram-force/square centimeter to 280 or less gram-force/square centimeter to a rigid metal plate placed on top of the adjacent carbon cover layer comprising carbon particles on the infused electrically conductive support is sufficient to obtain the level of electrical contact for the intended application without causing unnecessary damage to either the carbon particles or the electrically conductive support. Damage such as fracturing the carbon particles or pushing the carbon particles through the electrically conductive support are examples of such damage. Micro-cracking of the infused electrically conductive support or the carbon cover layer is another example of potential damage.

In another embodiment, a soft, compliant surface on the rigid metal plate could allow distribution of the applied force over a greater number of carbon particles and a greater surface area per carbon particle. This in turn should allow the application of higher pressures in some embodiments.

In one embodiment, curing is performed in an oven in an air environment. The temperature of the oven is increased in stages from room temperature to the final curing temperature at heating rates of from 6° C. to 15° C. per hour.

According to another embodiment, the oven initially can be held at a temperature greater than room temperature but less than the curing temperature. The number of stages between room temperature and the final curing temperature can range from 0 to 10, for example, from 0 to 5. The final curing temperature can range from 100° C. to 350° C., for example, 150° C. to 260° C. with hold times varying from 0.25 hours to 10 hours, for example, 0.5 hours to 4 hours. The electrodes are then cooled at a heating rate of from 1° C. to 50° C., for example, from 6° C. to 15° C. per hour to the gel point of the carbonizable material, for example, in the temperature range of from 100° C. to 225° C., for example, from 120° C. to 160° C. The electrodes are annealed at the gel point for 6 to 24 hours, after which the electrodes are cooled to room temperature at a heating rate of from 1° C. to 50° C., for example, from 6° C. to 15° C. per hour.

In one embodiment, carbonization is performed in a CM Rapid Temperature retort furnace. The electrodes are heated to the carbonization temperature in an inert, non-oxidizing environment such as N₂ or Ar using a heating rate of from 20° C. to 100° C. per hour. The gas flow rate ranges from 2.5 to 7.5 liters per min (STP). The carbonization temperature ranges of from 800° C. to 1300° C. The electrodes are held at the carbonization temperature for 1 hour to 12 hours and then cooled to room temperature at a heating rate of from 50° C. to 150° C. per hour.

According to another embodiment, the method further comprises activating the carbon electrode. Activation can be performed in, for example, a CM Rapid Temperature retort furnace. The electrodes which have been cured and carbonized are heated to the activation temperature in an inert, non-oxidizing environment utilizing an inert gas, for example, N₂ or Ar using a heating rate of from 125° C. to 250° C. per hour. The inert gas flow rate ranges from 2.5 to 7.5 liters per min (STP). After reaching the activation temperature, the gas environment is switched to a mildly oxidizing gas such as steam or CO₂ at a flow rate of from 1.5 to 4.0 liters per min (STP). The electrodes are held at the carbonization temperature for 1 hour to 12 hours, the gas environment is switched back to inert gas flow rate ranging from 2.5 to 7.5 liters per min (STP) and then the temperature is decreased to room temperature at a heating rate of from 50° C. to 150° C. per hour.

During the carbonization/activation process, a large number of micropores are formed in the surface of the carbon material. Micropores increase the surface area of the carbon which results in increased capacitance. Other conventional carbons for electrodes may be formed from cured synthetic precursors that are treated with alkali or acids and then further treated at high temperatures to create porosity.

The resulting carbon electrodes have excellent electrical conductivity because of their fully carbon nature and the integrated electrical backplane. The carbon electrodes show increased capacitive performance, resulting from highly effective utilization of the carbon particles in the carbon cover layer. Two carbon electrodes with exactly the same packing density but very different particle to particle connectivity can have disparate specific capacitance. A carbon electrode with high particle packing but low interparticle connectivity due to a dispersed microstructure will have low specific capacitance as the particles that are not connected to neighboring particles would have unused capacitance. The carbonized microstructure of the carbon electrodes of the present invention minimizes this problem by ensuring a conductive matrix.

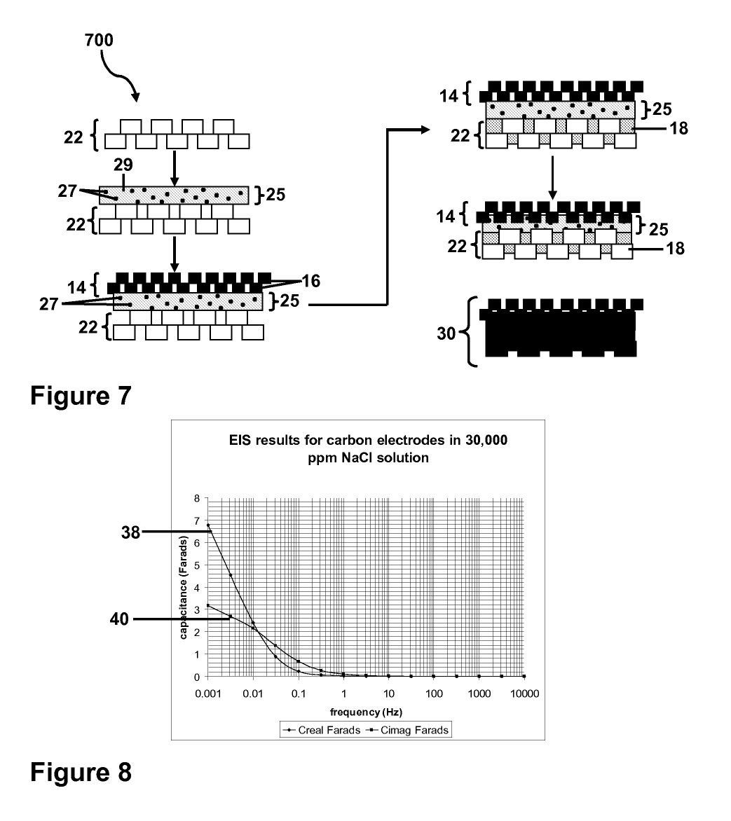

FIG. 7 shows an exemplary method 700 of making a carbon electrode according to another embodiment. The method comprises providing an electrically conductive porous layer 22, applying a carbonizable paste layer 25 comprising electrically conductive particles 27 and a carbonizable polymer material 29 to the electrically conductive porous layer 22, applying a carbon cover layer 14 comprising carbon particles or precursors thereof 16 to the paste layer, infusing the electrically conductive porous layer 22 with a carbonizable material 18, curing the carbonizable polymer 29 and the carbonizable material 18 and carbonizing the layers 14, 25 and 22 to form the carbon electrode 30.

In one embodiment, a thin layer of a carbonizable paste comprising electrically conductive particles mixed with carbonizable polymer material is tape-cast to one surface of the electrically conductive porous layer. Next, a carbon cover layer is applied to the carbonizable paste layer. A carbonizable material is infused into the porosity of the electrically conductive porous layer from the backside of the electrically conductive porous layer. The carbonizable material and the carbonizable polymer material is then cured under conditions previously described and subsequently carbonized under conditions previously described, forming a fully carbon electrode with a highly interconnected electric pathway.

According to another embodiment, the electrically conductive porous layer is first infused with the carbonizable material and partially cured by heating at a temperature below the curing temperature of the carbonizable material. The carbonizable paste layer is subsequently applied to the infused electrically conductive porous layer. The carbon cover layer is then applied to the carbonizable paste layer. The carbonizable material and the carbonizable polymer material is then cured under conditions previously described and subsequently carbonized under conditions previously described, forming a fully carbon electrode with a highly interconnected electric pathway.

According to another embodiment, the method further comprises activating the carbon electrode. Activation can be performed as previously described.

According to another embodiment, pressure may be applied to enhance direct electrical contact between the carbon cover layer and the support in the carbon electrode or in the layered structure as previously described.

FIG. 8 is a graph of the electrochemical impedance spectroscopy (EIS) test results for a carbon electrode according to one embodiment in 30,000 ppm NaCl solution. In FIG. 8, Creal 38 is capacitance which represents the electromagnetic (EM) field produced in the device and provides recoverable stored energy while Cimag 40 is apparent capacitance which is actually dissipative loss.

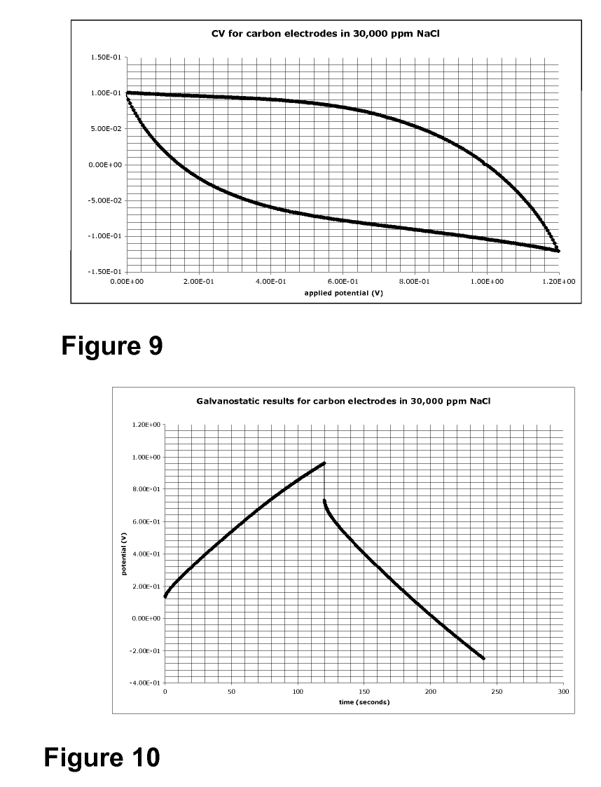

FIG. 9 is a graph of the Cyclic voltammetry (CV) test results for a carbon electrode according to one embodiment in 30,000 ppm NaCl solution. For this test, a pair of carbon electrodes according to the present invention was assembled into simple cell. A 55 micron thick fabric separator was located between the carbon electrodes. The test was performed using a Gamry PCI4 Potentiostat. The voltage difference was measured between carbon electrodes cycled using triangular waveform between 0 and 1.2 volt at rate of 10 mV/sec. The plot shows hysteresis in voltage/current response demonstrating the capacitive performance of the carbon electrodes.

FIG. 10 is a graph of the Galvanostatic test results for a carbon electrode according to one embodiment in 30,000 ppm NaCl solution. For this test, a pair of carbon electrodes according to the present invention was assembled into simple cell. A constant current of 75 mA was applied to the cell for 120 seconds and then reversed to −75 mA. The plot is accumulated potential (voltage) versus time. The small drop in potential upon reversal of current indicates low electrical resistance of the carbon electrodes.

The intrinsic capacitance of a material can be manipulated by changing the density of states. This offers an opportunity to enhance the overall double layer capacitance of a porous material such as activated carbon in the carbon electrodes of the present invention. The overall Electric Double Layer (EDL) capacitance, C_{EDL}, of a porous solid-solution matrix with a finite number of mobile charge carriers (electrons in the solid phase and ions in the solution phase) can be written as a series combination of two capacitors, the space charge capacitance of the solid phase C_{sc} and the electric double layer capacitance of the ionic solution, Cₑₗ (Gerischer, 1985). The latter capacitance can be expressed as a series combination of the Helmholtz capacitance, C_{H}, and the Gouy Chapman diffuse layer capacitance, C_{GC} and expressed by the following Formula I:

1/C_{EDL}=1/C_{sc}+1/Cₑₗ=1/C_{sc}+1/C_{H}+1/C_{GC} I

Usually, especially in the case of strong electrolytic solutions, the Gouy Chapman capacitance is large and hence the overall EDL capacitance can be dominated by the space charge and the Helmholtz capacitance. This offers an opportunity for enhancing the overall capacitance by increasing the space charge capacitance, if the space charge capacitance is lower than the Helmholtz capacitance. The space charge capacitance of a porous matrix filled with a specific electrolyte is a function of the density of state of the material and the characteristic pore diameter and/or pore size distribution. In general, the higher the absolute value of the density of state function, the higher is the space charge capacitance. The density of states in a solid can be enhanced by increasing the number of defect sites or edge sites both of which add to the population of energy states in the material offering more electronic capacitance.

The above described phenomena can be utilized to enhance the deionization capacity of a porous material, such as activated carbon in the carbon electrodes of the present invention. It may be possible to increase the crystalline defect density of activated carbon so as to increase the performance of the carbon electrodes of the present invention.

What is claimed is:

1. A carbon electrode comprising:
an electrically conductive porous carbon support;
an adjacent carbon cover layer comprising carbon particles in contact with the electrically conductive porous carbon support; and
a carbonized material within the electrically conductive porous carbon support and providing a bond to the carbon particles at the interface with the carbon cover layer.

2. The carbon electrode according to claim 1, wherein the electrically conductive porous carbon support is a single carbon layer infused with the carbonized material.

3. The carbon electrode according to claim 1, wherein the electrically conductive porous carbon support comprises two layers, wherein at least one layer is a carbonized paste layer comprising electrically conductive particles and a carbonized polymer material, wherein the carbonized paste layer is in contact with the carbon cover layer.

4. The carbon electrode according to claim 3, wherein the electrically conductive particles in the carbonized paste layer comprise carbon powder, carbon black, graphite, petroleum coke, fibers, filaments, rods or combinations thereof.

5. The carbon electrode according to claim 1, wherein the electrically conductive porous carbon support comprises a planar surface.

6. The carbon electrode according to claim 1, wherein the electrically conductive porous carbon support comprises carbon paper, carbon fibers, synthetic fiber carbon felt, carbon foam, carbon cloth or combinations thereof.

7. The carbon electrode according to claim 5, wherein the electrically conductive porous carbon support comprises a planar sheet from 50 to 500 microns in thickness.

8. The carbon electrode according to claim 1, wherein the electrically conductive porous carbon support is from 125 to 400 microns in thickness.

9. The carbon electrode according to claim 1, wherein the carbon particles in the carbon cover layer have an average diameter of from 10 microns to 1000 microns.

10. The carbon electrode according to claim 1, wherein the carbon particles in the carbon cover layer have an average diameter of from 75 microns to 600 microns.

11. The carbon electrode according to claim 1, wherein the carbon particles in the carbon cover layer have an average diameter of from 75 microns to 450 microns.

12. The carbon electrode according to claim 1, wherein the electrode comprises a hole extending through the thickness of the electrode.

13. The carbon electrode according to claim 12, wherein the hole is from 1 mm to 10 mm in diameter.

14. The carbon electrode according to claim 1, wherein the carbon particles in the carbon cover layer comprise high surface area carbon, activated carbon or combinations thereof.

15. A layered structure comprising:
an electrically conductive support;
an adjacent carbon cover layer comprising carbon particles or precursors thereof in contact with the electrically conductive support; and
a carbonizable material within the electrically conductive support and providing a bond to the carbon particles or precursors thereof at the interface with the carbon cover layer.

16. The layered structure according to claim 15, wherein the electrically conductive support is a single carbon layer infused with the carbonizable material.

17. The layered structure according to claim 15, wherein the electrically conductive support comprises two layers, wherein at least one layer is a carbonizable paste layer comprising electrically conductive particles and a carbonizable polymer material, wherein the carbonizable paste layer is in contact with the carbon cover layer.

18. The layered structure according to claim 17, wherein the carbonizable polymer material comprises a material selected from a phenol formaldehyde resole, a photoresist, a polyamide, a phenol formaldehyde novolac, a polyimide, a phenolic resin, an epoxy and combinations thereof.

19. The layered structure according to claim 17, wherein the electrically conductive particles in the carbonizable paste layer comprise carbon powder, carbon black, graphite, petroleum coke, fibers, filaments, rods or combinations thereof.

20. The layered structure according to claim 15, wherein the carbonizable material has a viscosity, when uncured, of from 100 to 20,000 centipoise (cP) at a temperature in the range of from 20° C. to 100° C.

21. The layered structure according to claim 20, wherein the carbonizable material has a viscosity, when uncured, of from 400 to 2000 centipoise (cP) at a temperature in the range of from 20° C. to 40° C.

22. The layered structure according to claim 15, wherein the carbonizable material comprises a material selected from a phenol formaldehyde resole, a photoresist, a polyamide, a phenol formaldehyde novolac, a polyimide, a phenolic resin, an epoxy, a petroleum pitch, a synthetic pitch and combinations thereof.

23. The layered structure according to claim 15, wherein the electrically conductive support comprises carbon paper, carbon fibers, synthetic fiber carbon felt, carbon foam, carbon cloth or combinations thereof.

24. The layered structure according to claim 15, wherein the carbon particles in the carbon cover layer comprise high surface area carbon, activated carbon or combinations thereof.

25. The layered structure according to claim 15, wherein the carbon precursor particles in the carbon cover layer comprise carbonizable polymer particles.

26. A method of making a carbon electrode, the method comprising:
providing an electrically conductive support;
infusing the electrically conductive support with a carbonizable material;
applying an adjacent carbon cover layer comprising carbon particles or precursors thereof to the electrically conductive support;
curing the carbonizable material; and
carbonizing the electrically conductive support and the carbon cover layer to form the carbon electrode.

27. The method according to claim 26, wherein the electrically conductive support is a single carbon layer that is then infused with the carbonizable material.

28. The method according to claim 26, wherein the electrically conductive support comprises two layers, wherein at least one layer is a carbonizable paste layer comprising electrically conductive particles and a carbonizable polymer material, wherein the carbonizable paste layer is in contact with the carbon cover layer.

29. The method according to claim 26, further comprising activating the carbon electrode.

30. A method of making a carbon electrode, the method comprising:
providing an electrically conductive porous layer;
applying a carbonizable paste layer comprising electrically conductive particles and a carbonizable polymer material to the electrically conductive porous layer;
applying a carbon cover layer comprising carbon particles or precursors thereof to the paste layer;
infusing the electrically conductive porous layer with a carbonizable material;
curing the carbonizable polymer material and the carbonizable material; and
carbonizing the layers to form the carbon electrode.

31. The method according to claim 30, further comprising activating the carbon electrode.
